(19) United States
(12) Patent Application Publication
(10) Pub. No.: US 2009/0090837 A1
(43) Pub. Date: Apr. 9, 2009

(54) Hanging Device with a Sucker Assembly

(76) Inventor: Te-San Chen, Tainan Hsien (TW)

Correspondence Address: Kamrath & Associates, P.A., 4825 Olson Memorial Highway, Suite 245, Golden Valley, MN, 55422, US

(21) Appl. No.: 11/868,549

(22) Filed: Oct. 8, 2007

(51) Int. Cl. F16M 13/02

(52) U.S. Cl. 248/560

(57) ABSTRACT

A hanging device with a sucker assembly has a sucker assembly and a hanging segment. The sucker assembly has a diaphragm, a sucker mount having an proximal end and being connected to the diaphragm, a sucker cover mounted around the sucker mount and abuts the diaphragm, an adjuster that screws around the sucker mount and a connector. The hanging segment has an end and a connector. The connectors of the sucker mount and the hanging segment connect to each other and may be a threaded rod engaging a threaded hole, a split plug held in a socket or be a protrusion engaging a recess. Therefore, the hanging device is hung firmly in a ceiling, a wall or the like by the sucker assembly.

### BACKGROUND OF THE INVENTION

1. Field of the Invention

The present invention relates to a hanging device with a sucker assembly, especially to a hanging device that connects firmly with a diaphragm.

2. Description of the Prior Arts

A sucker assembly may be applied to hang articles on it or to connect with articles to attach them to a surface of a wall. The sucker assembly is broadly used since it will not cause damage to the surfaces of the wall.

A conventional sucker assembly has a diaphragm, a sucker mount, a sucker cover and an adjuster. The diaphragm has an inner surface and a center. The sucker mount is attached to the center of the diaphragm and has a proximal end and an external thread. The proximal end of the sucker mount is attached to the inner surface of the diaphragm. The external thread is formed around the sucker mount. The sucker cover is mounted around the sucker mount and has an outer edge and an inner edge. The outer edge of the sucker cover abuts the inner surface of the diaphragm. The adjuster is mounted around the sucker mount and has an outer edge and a threaded inner wall. The outer edge of the adjuster abuts the inner edge of the sucker cover. The threaded inner wall of the adjuster corresponds and fastens to the external thread of the sucker mount.

When the diaphragm is applied to the surface of the wall and the adjuster screws toward the diaphragm, the sucker mount and the center of the diaphragm are pulled up and the outer edge of the sucker cover firmly abuts the inner surface of the diaphragm. Thus, air pressure between the diaphragm and the wall is smaller than air pressure outside the diaphragm and the diaphragm securely sucks on the surface of the wall.

However, though the conventional sucker assembly has strong suction to securely suck on the surface of the wall, there is no connection structure to allow the conventional sucker assembly to securely connect with the articles. The articles can only hang on the sucker mount, and may fall off from the sucker assembly easily.

To overcome the shortcomings, the present invention provides a hanging device with a sucker assembly to mitigate or obviate the aforementioned problems.

### SUMMARY OF THE INVENTION

The main objective of the present invention is to provide a hanging device with a sucker assembly that has a stable and strong connection.

The hanging device with the sucker assembly comprises a sucker assembly and a hanging segment. The sucker assembly has a diaphragm, a sucker mount having an proximal end and being connected to the diaphragm, a sucker cover mounted around the sucker mount and abuts the diaphragm, an adjuster that screws around the sucker mount and a connector. The hanging segment has an end and a connector. The connectors of the sucker mount and the hanging segment connect to each other and may be a threaded rod engaging a threaded hole, a split plug held in a socket or be a protrusion engaging a recess. Therefore, the hanging device is hung firmly in a ceiling, a wall or the like by the sucker assembly.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a hanging device with a sucker assembly in accordance with the present invention;

FIG. 2 is a side view in partial section of the hanging device in FIG. 1;

FIG. 3 is a side view in partial section of the hanging device in FIG. 1, shown attached to a surface;

FIG. 4 is an exploded perspective view of a second embodiment of a hanging device with a sucker assembly in accordance with the present invention;

FIG. 5 is an exploded perspective view of a third embodiment of a hanging device with a sucker assembly in accordance with the present invention;

FIG. 6 is an exploded perspective view of a fourth embodiment of a hanging device with a sucker assembly in accordance with the present invention;

FIG. 7 is an exploded perspective view of a fifth embodiment of a hanging device with a sucker assembly in accordance with the present invention;

FIG. 8 is an exploded perspective view of a sixth embodiment of a hanging device with a sucker assembly in accordance with the present invention;

FIG. 9 is an exploded perspective view of a seventh embodiment of a hanging device with a sucker assembly in accordance with the present invention;

FIG. 10 is an exploded perspective view of an eighth embodiment of a hanging device with a sucker assembly in accordance with the present invention;

FIG. 11 is an exploded perspective view of a ninth embodiment of a hanging device with a sucker assembly in accordance with the present invention; and

FIG. 12 is an exploded perspective view of a tenth embodiment of a hanging device with a sucker assembly in accordance with the present invention;

### DETAILED DESCRIPTION OF THE PREFERRED EMBODIMENTS

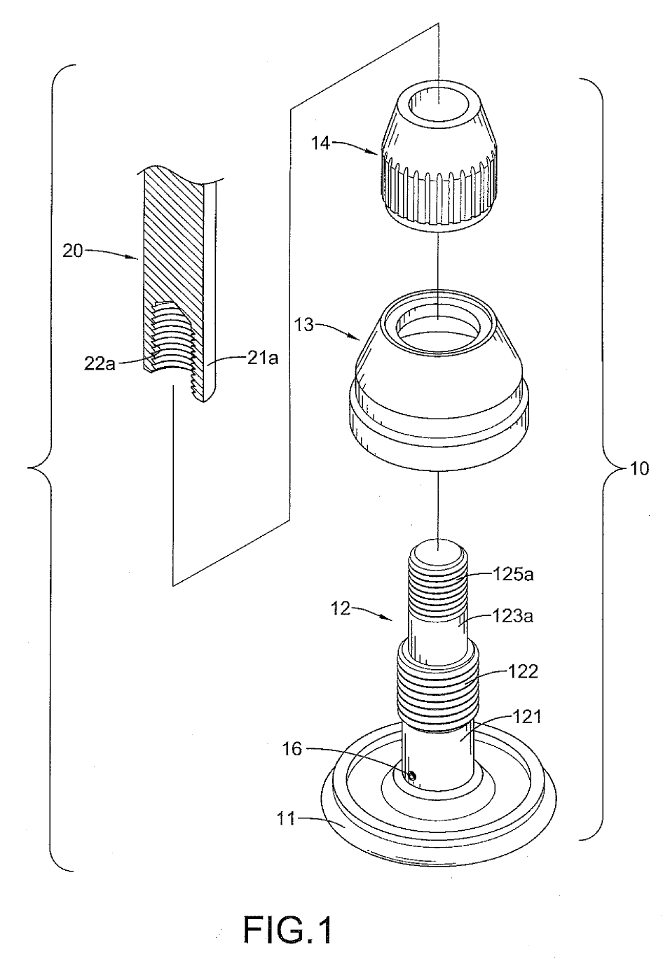

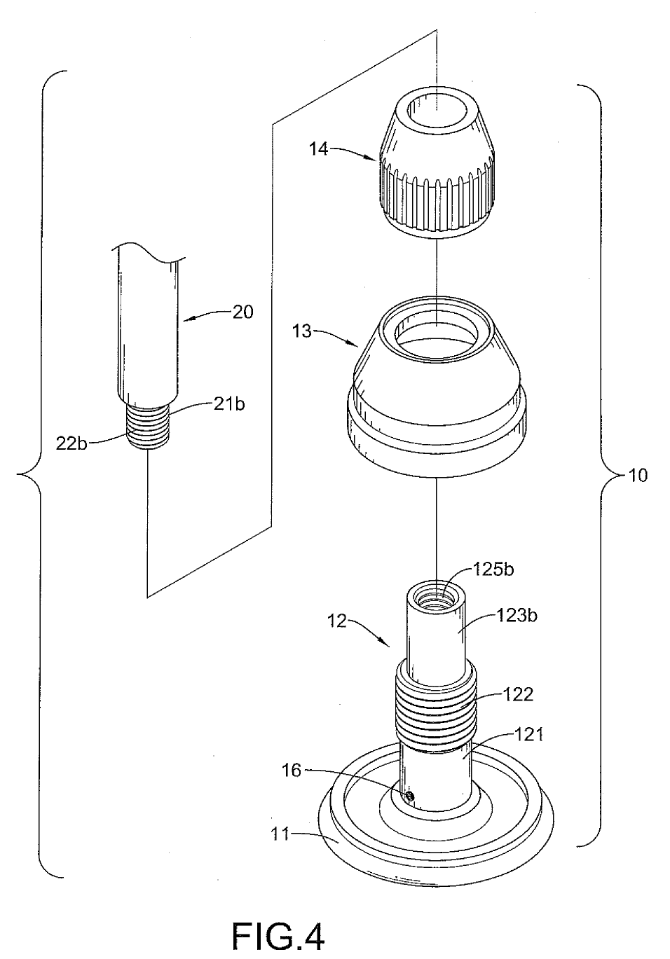

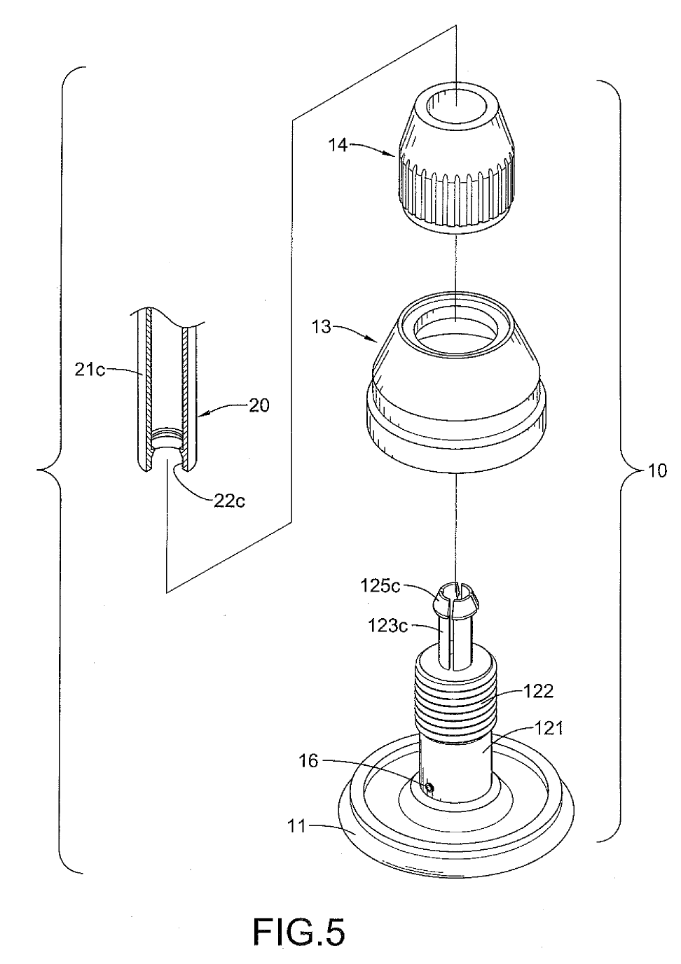

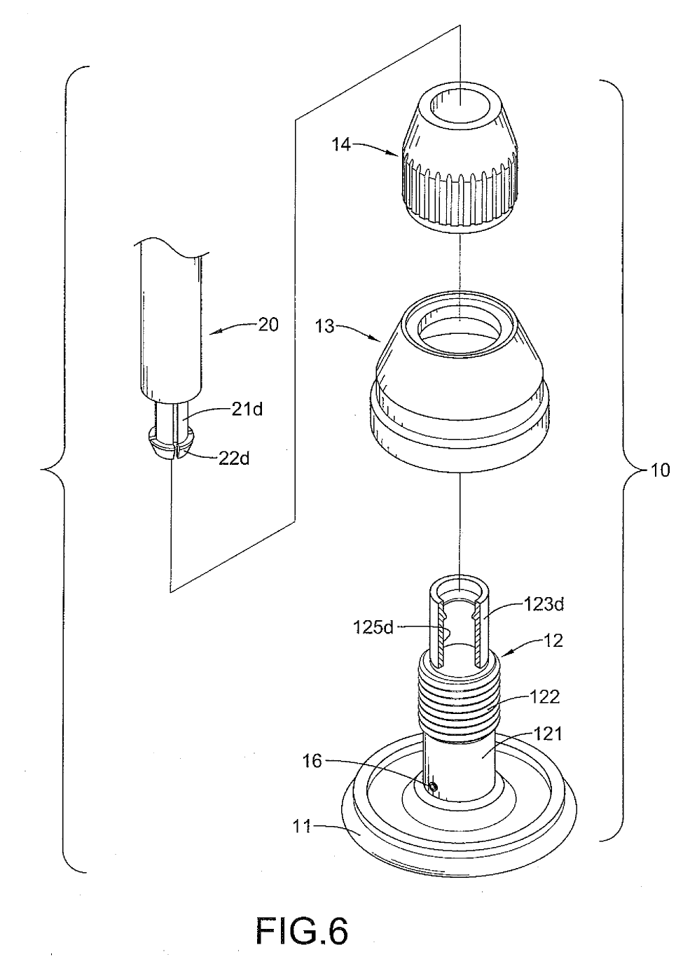

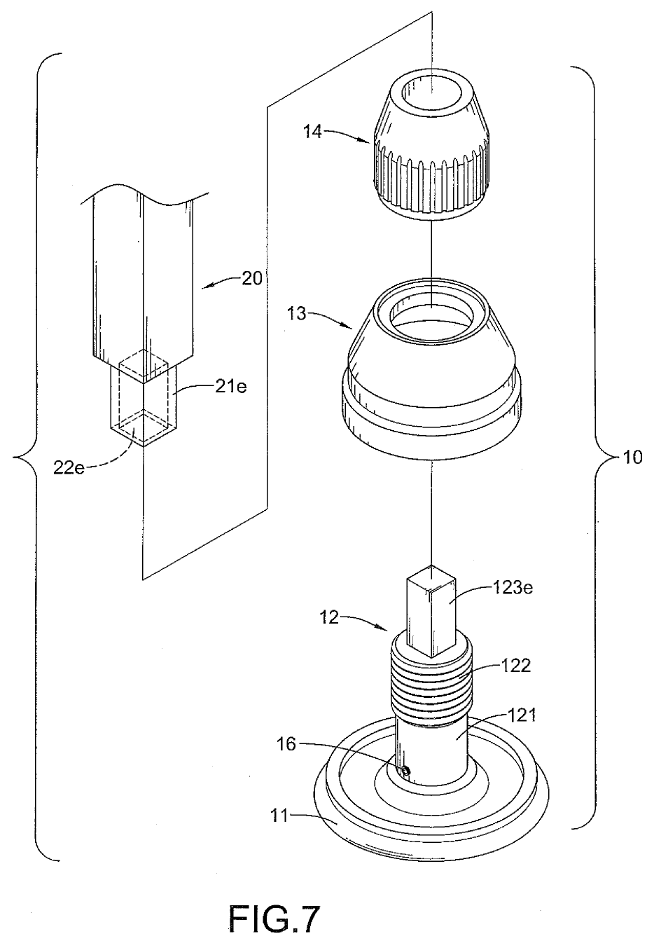

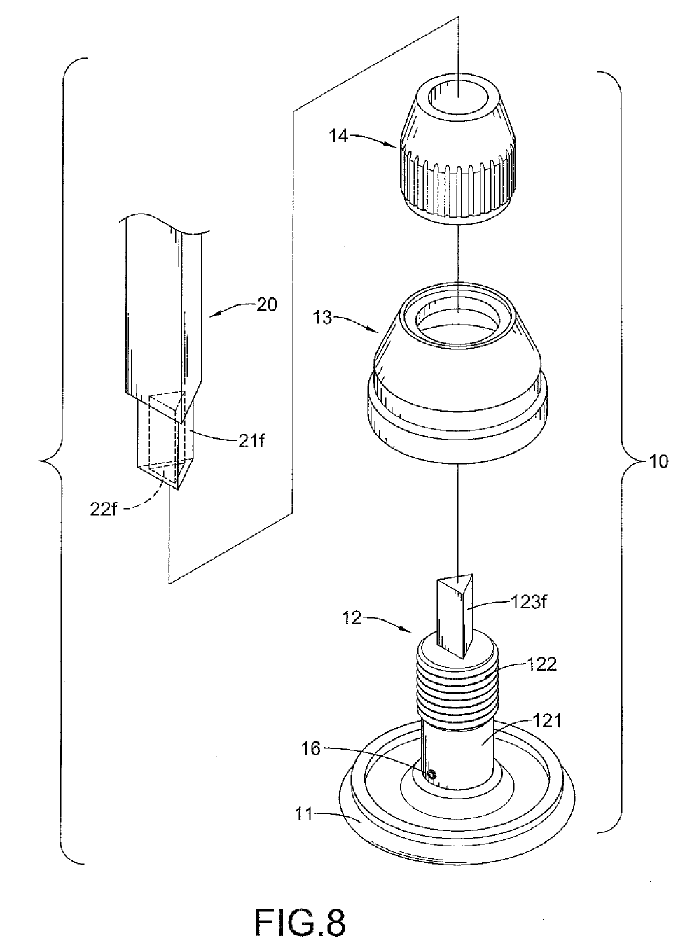

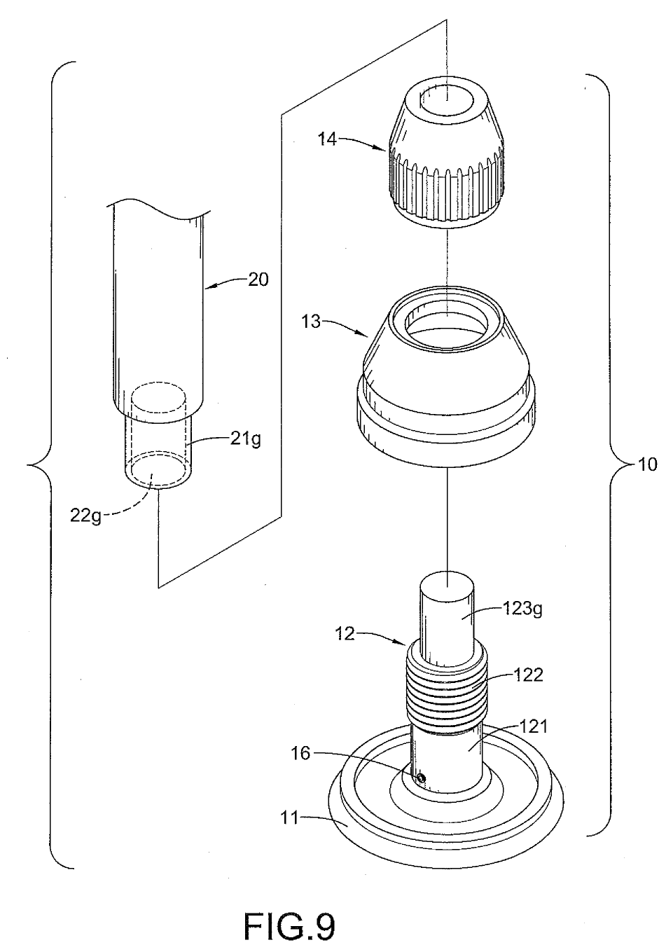

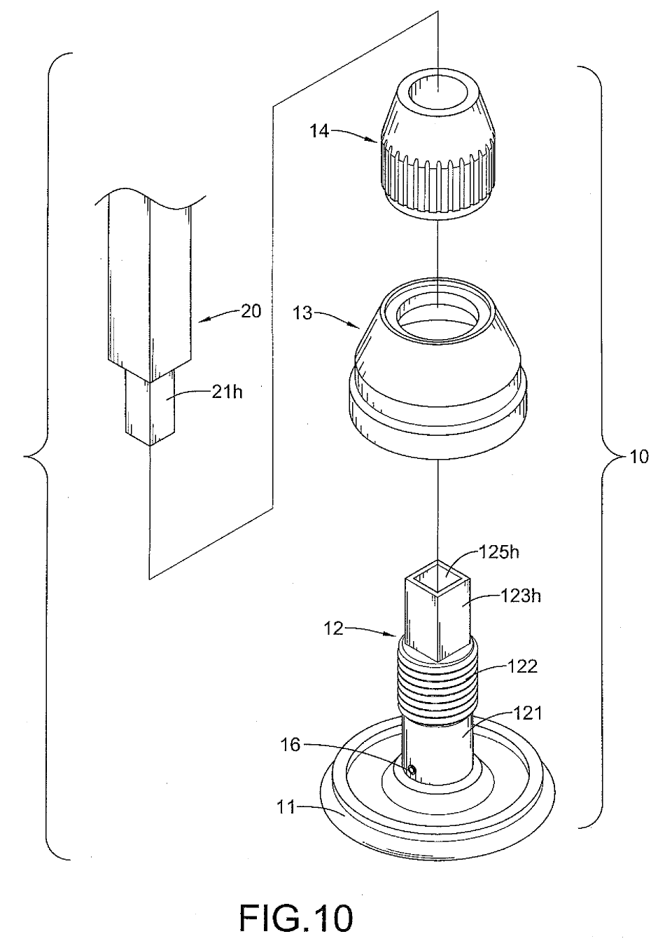

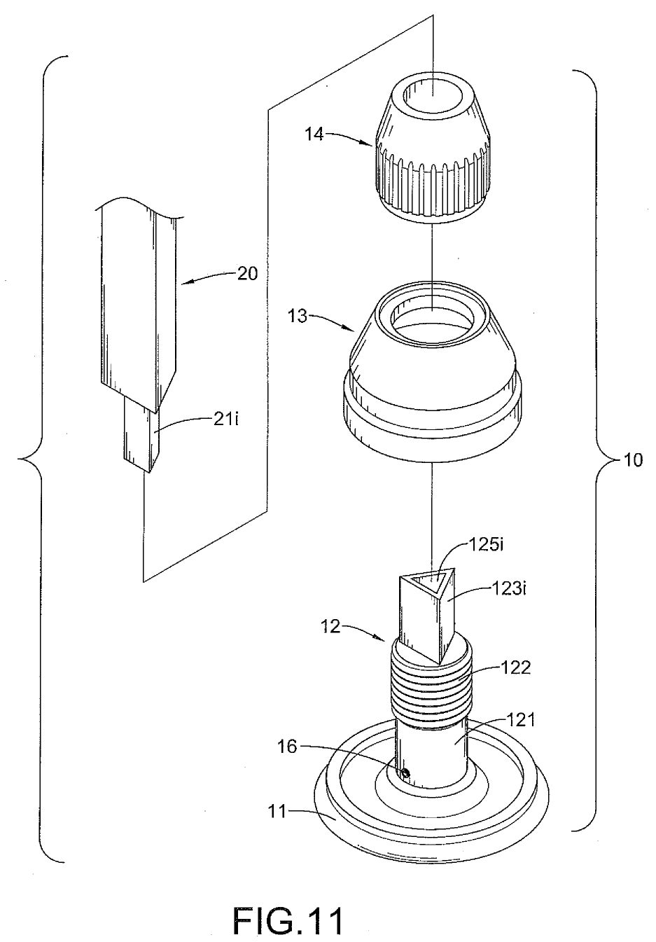

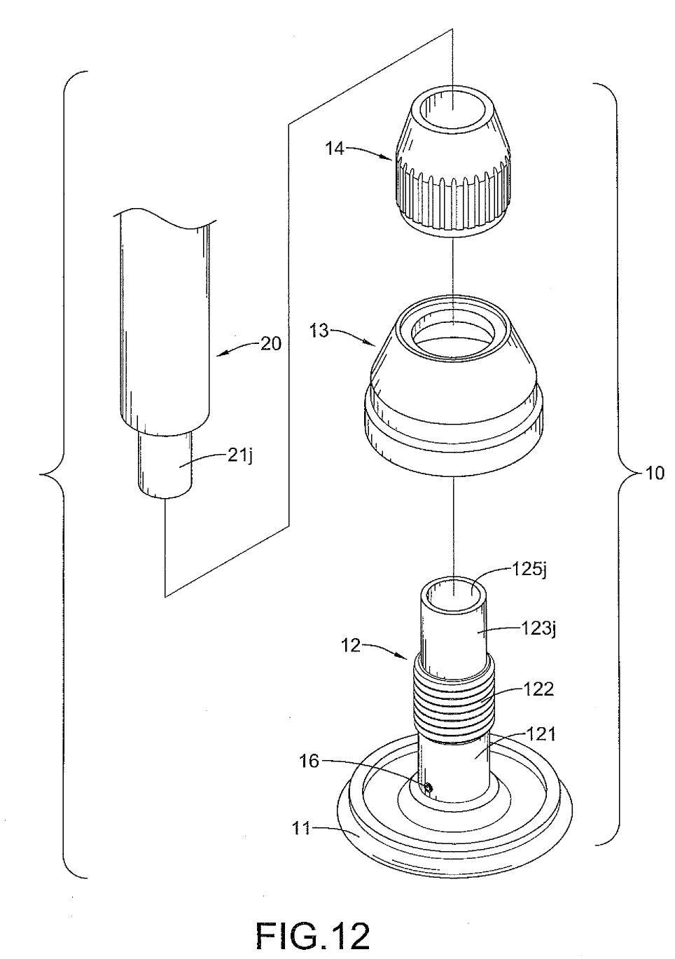

With reference to FIGS. 1 and 4 to 12, a hanging device with a sucker assembly in accordance with the present invention comprises a sucker assembly (10) and a hanging segment (20).

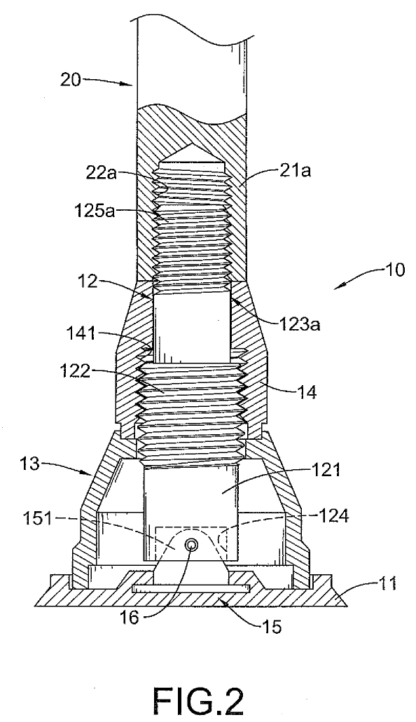

With further reference to FIG. 2, the sucker assembly (10) has a diaphragm (11), an optional diaphragm mount (15), a sucker mount (12), an optional pin (16), a sucker cover (13) and an adjuster (14).

The diaphragm (11) is a resilient disk and has an inner surface. The inner surface has an edge and a center.

The diaphragm mount (15) is mounted securely in the center of the inner surface of the diaphragm (11) and has an inner surface and a pivoting protrusion (151). The pivoting protrusion (15 1) is formed on and protrudes away from the inner surface of the diaphragm mount (I 5).

The sucker mount (12) is attached to the center of the inner surface of the diaphragm (11) and has a distal end, a proximal end (121), an optional pivoting recess (124), a threaded outer surface (122), and a first connector. The proximal end (121) is attached to the center of the inner surface of the diaphragm (I 1). The pivoting recess (124) is formed coaxially in the proximal end (121) of the sucker mount (12), is mounted around the pivoting protrusion (151) of the diaphragm mount (15) and has a sidewall. The threaded outer surface (122) is formed around the sucker mount (12). The first connector is formed on and protrudes from the distal end of the sucker mount (12) and maybe a threaded rod (123a), a threaded sleeve (123b), a split plug (123c), a plug sleeve (123d), a protrusion (123e, 123f, 123g) or a polygon sleeve (123h, 123i, 123j).

The threaded rod (123a) has an external thread (125a). The external thread (125a) is formed around the threaded rod (123a).

The threaded sleeve (123b) has a threaded hole (125b). The threaded hole (125b) is formed coaxially in the threaded sleeve (123b).

The split plug (123c) has multiple lips (125c).

The plug sleeve (123d) has a socket (125d). The socket (125d) is formed coaxially in the plug sleeve (123d).

The protrusion (123e, 123f, 123g) may be quadrangular, triangular or circular in cross section.

The polygon sleeve (123h, 123i, 123j) may have a quadrangular hole (125h), a triangular hole (125i) or a circular hole (125j) formed coaxially in the polygon sleeve (123h, 123i, 123j).

The pin (16) extends through the sidewall of the pivoting recess (124) and the pivoting protrusion (151) of the diaphragm mount (15) to connect the diaphragm mount (15) pivotally to the sucker mount (12).

The sucker cover (13) is mounted movably around the sucker mount (12) and has an outer edge and an inner edge. The outer edge of the sucker cover (13) abuts the edge of the inner surface of the diaphragm (11).

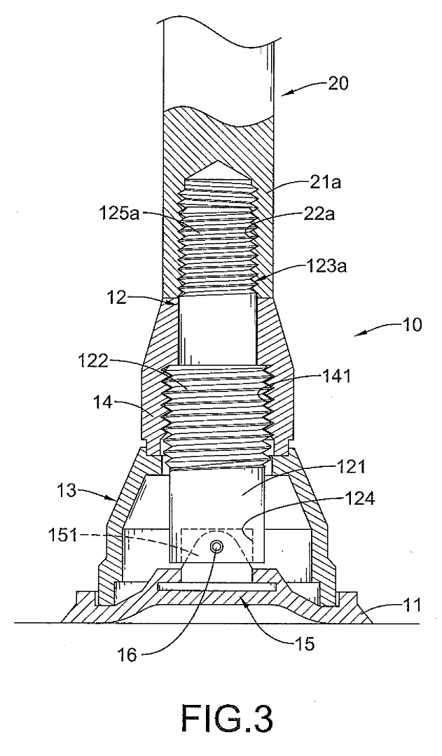

With further reference to FIG. 3, the adjuster (14) is mounted rotatably around the sucker mount (12), selectively screws down toward the diaphragm (11) to pull the sucker mount (12) together with the diaphragm (11) up and has an outer edge, an inner edge and a threaded inner wall (141). The outer edge of the adjuster (14) abuts the inner edge of the sucker cover (13) to ensure the outer edge of the sucker cover (13) firmly abuts the edge of the inner surface of the diaphragm (11) when the center of the inner surface of the diaphragm (11) is pulled up together with the sucker mount (12). The inner threaded wall (141) corresponds and fastens to the threaded outer surface (122) of the sucker mount (12).

The hanging segment (20) has an end and a second connector.

The end of the hanging segment (20) abuts the inner edge of the adjuster (14).

The second connector is formed on and protrudes from the end of the hanging segment (20), is selectively connected to the first connector of the sucker mount (12) and may be a threaded sleeve (21a), a threaded rod (21b), a plug sleeve (21c), a split plug (21d), a polygon sleeve (21e, 21f, 21g) or a protrusion (21h, 21i, 21j).

The threaded sleeve (21a) is selectively mounted around the threaded rod (123a) of the sucker mount (12) and has a threaded hole (22a). The threaded hole (22a) is formed coaxially in the threaded sleeve (21a) and corresponds and selectively engages the external thread (125a) of the threaded rod (123a) of the sucker mount (12).

The threaded rod (21b) is selectively mounted in the threaded sleeve (123b) of the sucker mount (12) and has an external thread (22b). The external thread (22b) is formed around the threaded rod (12) and corresponds and selectively fastens to the threaded hole (125b) of the threaded sleeve (12b) of the sucker mount (12).

The plug sleeve (21c) is selectively mounted around the split plug (123c) of the sucker mount (12) and has a socket (22c). The socket (22c) is formed coaxially in the plug sleeve (21) of the hanging segment (20) and corresponds and selectively holds the lips (125c) of the split plug (123c) of the sucker mount (12).

The split plug (21d) is selectively mounted in the plug sleeve (123d) and has multiple lips (22d). The lips (22d) corresponds and are selectively held in the socket (125d) of the plug sleeve (12d) of the sucker mount (12).

The polygon sleeve (21e, 21f, 21g) is securely and selectively mounted around the protrusion (123e, 123f, 123g) and may have a quadrangular hole (22e), a triangular hole (22f) or a circular hole (22g) formed coaxially in the polygon sleeve (21e, 21f, 21g). The quadrangular hole (22e) corresponds and engages the quadrangular protrusion (123e) of the sucker mount (I 2). The triangular hole (22f) corresponds and engages the triangular protrusion (123f) of the sucker mount (12). The circular hole (22g) corresponds and engages the circular protrusion (123g) of the sucker mount (12).

The protrusion (21h, 21i, 21j) is securely and selectively mounted in the polygon sleeve (123h, 123i, 123j) of the sucker mount (12) and maybe quadrangular, triangular or circular in cross section. The quadrangular protrusion (21h) corresponds and engages in the quadrangular hole (125h) of the polygon sleeve (123h) of the sucker mount (12). The triangular protrusion (21i) corresponds and engages in the triangular hole (125i) of the polygon sleeve (123i) of the sucker mount (12). The circular protrusion (21j) corresponds and engages in the circular hole (125j) of the recess (123j) of the sucker mount (12).

The hanging device with a sucker assembly as described has the following advantages. The first and second connectors allow the hanging segment (20) to be held firmly with the sucker assembly (10). Thus, the hanging device is hung firmly in a ceiling, a wall or the like by the sucker assembly (10).

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the fall extent indicated by the broad general meaning of the terms in which the appended claims are expressed.

What is claimed is:

1. A hanging device comprising
a sucker assembly having
a diaphragm being a resilient disk and having an inner surface having
an edge; and
a center;
a sucker mount being attached to the center of the inner surface of the diaphragm and having
a distal end;
a proximal end being attached to the center of the inner surface of the diaphragm;
a threaded outer surface being formed around the sucker mount; and
a first connector being formed on and protruding from the distal end of the sucker mount;
a sucker cover being mounted movably around the sucker mount and having
an outer edge abutting the edge of the inner surface of the diaphragm; and
an inner edge; and
an adjuster being mounted rotatably around the sucker mount, selectively screwing down toward the diaphragm and having
an outer edge abutting the inner edge of the sucker cover;
an inner edge; and
a threaded inner wall corresponding and fastening to the threaded outer surface of the sucker mount; and
a hanging segment having
an end abutting the inner edge of the adjuster; and
a second connector being formed on and protruding from the end of the hanging segment and being selectively connected to the first connector of the sucker mount.

2. The hanging device as claimed in claim 1, wherein
the sucker assembly further has a diaphragm mount being mounted securely in the center of the inner surface of the diaphragm and having
an inner surface; and
a pivoting protrusion being formed on and protruding away from the inner surface of the diaphragm mount;
the sucker mount has a pivoting recess being formed coaxially in the proximal end of the sucker mount, being mounted around the pivoting protrusion of the diaphragm mount and having a sidewall; and
the sucker assembly further has a pin extending through the sidewall of the pivoting recess and the pivoting protrusion of the diaphragm mount.

3. The hanging device as claimed in claim 1, wherein
the first connector of the sucker mount is a threaded rod having an external thread being formed around the threaded rod; and
the second connector of the hanging segment is a threaded sleeve being selectively mounted around the threaded rod of the sucker mount and having a threaded hole being formed in the threaded sleeve and corresponding and selectively engaging the external thread of the threaded rod of the sucker mount.

4. The hanging device as claimed in claim 2, wherein
the first connector of the sucker mount is a threaded rod having an external thread being formed around the threaded rod; and
the second connector of the hanging segment is a threaded sleeve being selectively mounted around the threaded rod of the sucker mount and having a threaded hole being formed in the threaded sleeve and corresponding and selectively engaging the external thread of the threaded rod of the sucker mount.

5. The hanging device as claimed in claim 1, wherein
the first connector of the sucker mount is a threaded sleeve having a threaded hole being formed coaxially in the threaded sleeve; and
the second connector of the hanging segment is a threaded rod being selectively mounted in the threaded sleeve of the sucker mount and having an external thread being formed around the threaded rod and corresponding and selectively engaging the threaded hole of the threaded sleeve of the sucker mount.

6. The hanging device as claimed in claim 2, wherein
the first connector of the sucker mount is a threaded sleeve having a threaded hole being formed coaxially in the threaded sleeve; and
the second connector of the hanging segment is a threaded rod being selectively mounted in the threaded sleeve of the sucker mount and having an external thread being formed around the threaded rod and corresponding and selectively engaging the threaded hole of the threaded sleeve of the sucker mount.

7. The hanging device as claimed in claim 1, wherein
the first connector of the sucker mount is a split plug having multiple lips; and
the second connector of the hanging segment is a plug sleeve being selectively mounted around the split plug of the sucker mount and having a socket being formed coaxially in the plug sleeve of the hanging segment and corresponding and selectively holding the lips of the split plug of the sucker mount.

8. The hanging device as claimed in claim 2, wherein
the first connector of the sucker mount is a split plug having multiple lips; and
the second connector of the hanging segment is a plug sleeve being selectively mounted around the split plug of the sucker mount and having a socket being formed coaxially in the plug sleeve of the hanging segment and corresponding and selectively holding the lips of the split plug of the sucker mount.

9. The hanging device as claimed in claim 1, wherein
the first connector of the sucker mount is a plug sleeve having a socket being formed coaxially in the plug sleeve; and
the second connector of the hanging segment is a split plug being selectively mounted in the plug sleeve and having multiple lips corresponding and being selectively held in the socket of the plug sleeve of the sucker mount.

10. The hanging device as claimed in claim 2, wherein
the first connector of the sucker mount is a plug sleeve having a socket being formed coaxially in the plug sleeve; and
the second connector of the hanging segment is a split plug being selectively mounted in the plug sleeve and having multiple lips corresponding and being selectively held in the socket of the plug sleeve of the sucker mount.

11. The hanging device as claimed in claim 1, wherein
the first connector of the sucker mount is a protrusion; and
the second connector of the hanging segment is a polygon sleeve being securely and selectively mounted around the protrusion.

12. The hanging device as claimed in claim 11, wherein
the protrusion of the sucker mount is quadrangular in cross section; and
the second connector of the hanging segment has a quadrangular hole being formed coaxially in the polygon sleeve and corresponding and engaging the protrusion of the sucker mount.

13. The hanging device as claimed in claim 11, wherein
the protrusion of the sucker mount is triangular in cross section; and
the second connector of the hanging segment has a triangular hole being formed coaxially in the polygon sleeve and corresponding and engaging the protrusion of the sucker mount.

14. The hanging device as claimed in claim 11, wherein
the protrusion of the sucker mount is circular in cross section; and
the second connector of the hanging segment has a circular hole being formed coaxially in the polygon sleeve and corresponding and engaging the protrusion of the sucker mount.

15. The hanging device as claimed in claim 2, wherein
the first connector of the sucker mount is a protrusion; and
the second connector of the hanging segment is a polygon sleeve being securely and selectively mounted around the protrusion.

16. The hanging device as claimed in claim 1, wherein
the first connector of the sucker mount is a polygon sleeve; and
the second connector of the hanging segment is a protrusion being securely and selectively engaging in the polygon sleeve of the sucker mount.

17. The hanging device as claimed in claim 16, wherein
the polygon sleeve has a quadrangular hole being formed coaxially in the polygon sleeve; and
the protrusion of the hanging segment is quadrangular in cross section and corresponds and engages in the quadrangular hole of the polygon sleeve of the sucker mount.

18. The hanging device as claimed in claim 16, wherein
the polygon sleeve has a triangular hole being formed coaxially in the polygon sleeve; and
the protrusion of the hanging segment is triangular in cross section and corresponds and engages in the triangular hole of the polygon sleeve of the sucker mount.

19. The hanging device as claimed in claim 16, wherein
the polygon sleeve has a circular hole being formed coaxially in the polygon sleeve; and
the protrusion of the hanging segment is circular in cross section and corresponds and engages in the circular hole of the recess of the sucker mount.

20. The hanging device as claimed in claim 2, wherein
the first connector of the sucker mount is a polygon sleeve; and
the second connector of the hanging segment is a protrusion being securely and selectively engages in the polygon sleeve of the sucker mount.
